(19) United States
(12) Patent Application Publication
(10) Pub. No.: US 2002/0121714 A1
(43) Pub. Date: Sep. 5, 2002

(54) Automobile interior components that satisfy impact standards and a method for manufacturing the same

(76) Inventor: Darius J. Preisler, Macomb, MI (US)

Correspondence Address: WELSH & KATZ, LTD, 120 S RIVERSIDE PLAZA, 22ND FLOOR, CHICAGO, IL, 60606, US

(21) Appl. No.: 09/797,062

(22) Filed: Mar. 1, 2001

(51) Int. Cl. B29C 45/14; B29C 70/68

(52) U.S. Cl. 264/46.4; 264/259

(57) ABSTRACT

An automobile interior component having a honeycomb structure is disclosed. The honeycomb structure is bonded to the automobile interior component by inserting the honeycomb structure into the molding apparatus, and then molding the automobile interior component around the honeycomb structure. The honeycomb structure has a sufficient size to allow the automobile interior component to meet certain safety standards, such as head impact collision standards, when the automobile interior component is mounted on the frame of a vehicle.

### FIELD OF THE INVENTION

The present invention generally relates to automobile interior components and, more particularly, to an automobile interior component that is constructed to satisfy certain impact standards and a method for manufacturing the same.

### BACKGROUND OF THE INVENTION

U.S. Pat. No. 5,683,782 discloses a process for producing a thermoplastic sandwich material that includes a honeycomb structure. Referring to FIG. 1 of U.S. Pat. No. 5,683,782, a greatly enlarged sectional representation of a honeycomb segment with a cover layer is shown. In accordance with the invention disclosed in this patent, a thermoplastic sandwich material is made from two outer reinforced thermoplastic skins with a cellular core at the center that is molded by a thermocompression process. The skins are formed from polypropylene with continuous glass mats or are formed by woven glass with polypropylene fibers. The content of U.S. Pat. No. 5,683,782 is incorporated by reference into this application as if fully set forth herein.

Thermoplastic sandwich materials such as those disclosed in U.S. Pat. No. 5,683,782 have been utilized in a variety of different applications. For example, U.S. patent application Ser. No. 09/451,970, filed Nov. 30, 1999 discloses a method for molding an impact resistant automotive part such as a bumper beam. A thermoplastic reinforced fiber structure at least partially forms a pair of attachment portions of the automotive part and continuously extends between the attachment portions to link the attachment portions. The content of the 09/451,970 patent application is incorporated by reference into this application as if fully set forth herein.

In another example, U.S. patent application Ser. No. 09/445,356, filed Dec. 10, 1999 discloses a method of making a composite panel that has a sandwich structure and that is provided with a hinge. The panel comprises a stack that includes at least one first skin of a reinforced thermoplastic material and a second skin of a thermoplastic material. The panel is formed by preheating the first and second skins to a softening temperature, and then pressing the stack of skins at a pressure that lies in a predetermined range. The content of the 09/445,356 patent application is incorporated by referenced into this application as if fully set forth herein.

Yet another exemplary use of thermoplastic sandwich material is disclosed in U.S. patent application Ser. No. 09/485,142, filed Feb. 4, 2000. This application discloses a method of making a reinforced composite panel of the sandwich type having a cellular-core. The content of the 09/485,142 application is incorporated by reference into this application as if fully set forth herein.

U.S. patent application Ser. No. 09/525,346, filed Mar. 15, 2000 discloses the utilization of thermoplastic sandwich material in a certain application. In particular, this application discloses a method and system for co-molding a thermoplastic material with a thermoplastic sandwich material to form a thermoplastic sandwich article. The article has a thermoplastic inner portion. The content of 09/525,346 patent application is incorporated by reference into this application as if fully set forth herein.

U.S. patent application entitled “Method and System For Molding Thermoplastic Sandwich Material and Deep-Drawn Article Produced Thereby,” filed Mar. 15, 2000 discloses a method and system for molding a thermoplastic sandwich material to form a deep-drawn article. In particular, an inner portion of a blank of thermoplastic sandwich material is forced into a female die along a vertical axis to form a deep-drawn article. A step of clamping may be performed at a plurality of spaced outer portions of the blank immediately adjacent the female die. The content of the above-referenced “Method and System” patent application is incorporated by reference into this application as if fully set forth herein.

As discussed above, thermoplastic sandwich materials are being used in a variety of different automobile applications. It should be noted that typical automobiles comprise a hard steel frame body which forms the skeleton of the car. The hard steel frame body is designed to meet various strength requirements necessary to protect the vehicle occupant from injury in a collision. To provide the interior of the car with an aesthetically pleasing appearance, automobiles are designed with interior components such as a dashboard, pillars, headliners, consoles and the like.

In the event of a vehicle collision, an occupant may be injured if he or she comes into contact with the automobile interior component that typically is rigidly connected to the hard frame body inside of the vehicle. To protect the occupant from the hard frame structure, a number of governmental regulations regarding safety requirements, such as the head impact collision requirement FMUSS201, have been promulgated. A number of automobile interior components that currently are on the market do not satisfy these requirements.

### BRIEF SUMMARY OF THE INVENTION

It is desirable to provide an automobile interior component that satisfies certain safety requirements such as, for example, head impact collision standards. In accordance with one aspect of the invention, a honeycomb structure is integrally bonded to an automobile interior component by the utilization of a molding process such as, for example, an inserting molding process. A mold having an article defining cavity is provided for forming the automobile interior component into a desired shape. The honeycomb structure is inserted into the cavity of the article defining mold, and the automobile interior component is formed around the honeycomb structure, thereby integrally bonding the honeycomb structure to the automobile interior component.

Providing such an automobile interior component and a method for manufacturing the same provides a number of distinct advantages. For example, utilizing a honeycomb structure in the above-described manner causes the automobile interior component to have certain physical characteristics so as to be able to satisfy certain safety requirements such as, for example, head impact collision standards. Furthermore, manufacturing such an automobile interior component includes a fewer number of steps because the honeycomb structure is affixed to the automobile interior component while it is being manufactured.

Other features and advantages of the invention will become apparent from the description that follows.

### BRIEF DESCRIPTION OF THE DRAWINGS

The objects and advantages of the present invention will become more readily apparent to those of ordinary skill in the relevant art after reviewing the following detailed description and accompanying drawings, wherein:

FIG. 1 is a schematic representation of a top view of a van that illustrates a number of automobile interior components that include certain aspects of the present invention disclosed herein;

FIG. 2 is a front view of the B pillar component 24 shown in FIG. 1;

FIG. 3 is a rear view of the B pillar component 24 shown in FIGS. 1 and 2;

FIG. 4 is a rear view of the B pillar component 24, similar to FIG. 3, illustrating honeycomb structures 60 and 62;

FIG. 5A is a bottom, perspective view of honeycomb structure 60; and

FIG. 5B is a top, perspective view of the honeycomb structures 60 and 62 shown in FIG. 4; and

FIG. 6 is a side, schematic view of a mold 90 that is used to form automobile interior components in accordance with certain aspects of the present invention.

### DETAILED DESCRIPTION OF THE INVENTION

While the present invention is susceptible of embodiment in various forms, there is shown in the drawings a number of presently preferred embodiments that are discussed in greater detail hereafter. It should be understood that the present disclosure is to be considered as an exemplification of the present invention, and is not intended to limit the invention to the specific embodiments illustrated. It should be further understood that the title of this section of this application (“Detailed Description Of The Invention”) relates to a requirement of the United States Patent Office, and should not be found to be limiting to the subject matter disclosed herein.

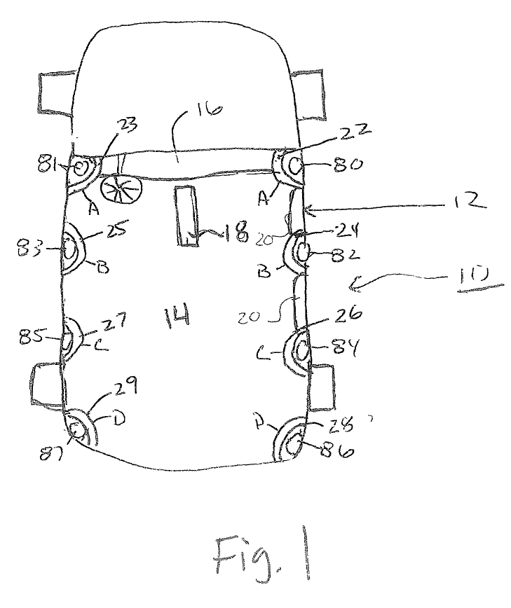

Referring now to FIG. 1, there is shown a schematic representation of a van 10 having a frame body 12. The frame body 12 includes upright portions 80-87, which extend from the main portion of the frame body 12 to a roof portion (not shown). The frame body 12 defines an interior 14 in which various automobile interior components are mounted. In the illustrated embodiment of the invention, interior 14 includes a dashboard 16, an interior console 18, side paneling 20, and pillars 22-29. It also should be understood that the present invention is applicable in other automotive applications such as, for example, in a headliner application (not shown). In the illustrated embodiment, four sets of pillars (A, B, C, and D) are shown. The pillars are mounted to cover the corresponding uprights 80-87 of the frame body 12.

The A, B, C, and D pillars are coupled to corresponding upright portions of the frame body 12. The A pillars are coupled to a corresponding first upright portion 80 and 81. The B pillars are coupled to corresponding second upright portions 82 and 83 that are located in a mid-portion of the vehicle, behind the front-side window. The C pillars are coupled to corresponding third upright portions 84 and 85 that are located behind the B pillar, near the rear portion of the vehicle. The D pillars are coupled to corresponding fourth upright portions 86 and 87 at the rear of the van. It should be understood that the number uprights (and pillars) vary in accordance with the general size of the vehicle.

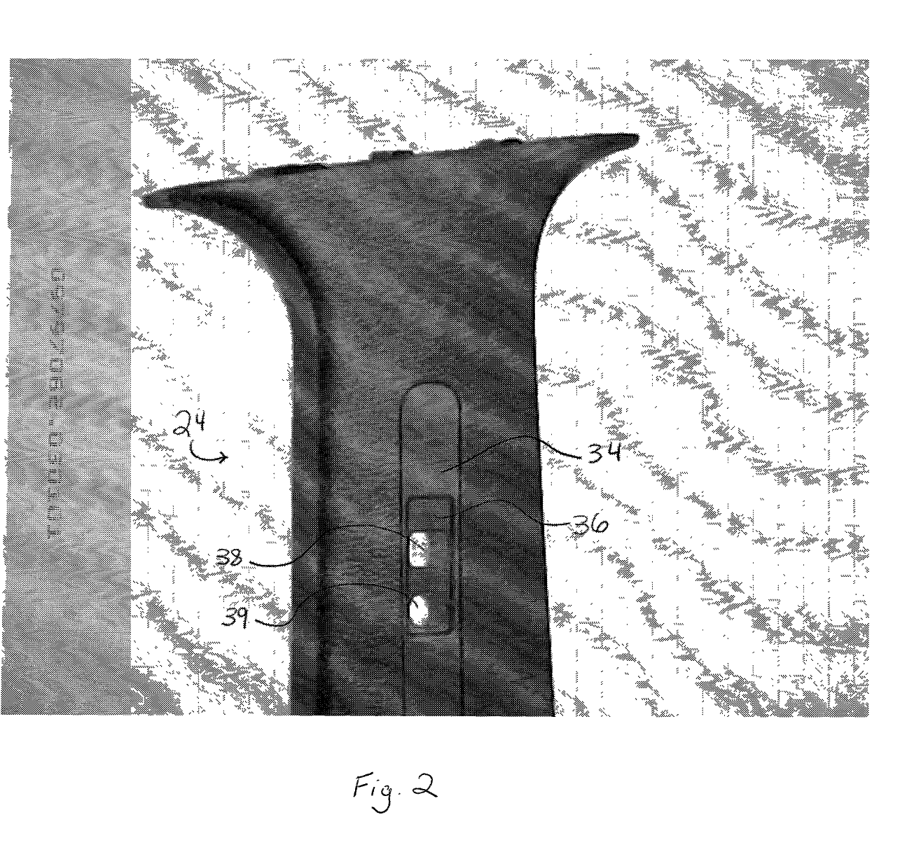

Referring to FIG. 2, a front view of the B pillar 24 (FIG. 1) is shown. The B pillar 24 includes a sliding mechanism 34 that is configured to receive a shoulder strap from a seat belt assembly (not shown). The sliding mechanism 34 has a movable slot 36 with plural holes 38 and 39 defined therein. In the illustrated embodiment of the invention, the sliding mechanism 34 is in operative connection to the B pillar 24 and slidably moves with respect to the B pillar 24. By manipulating the mechanism 34, the orientation of the seatbelt with respect to the B pillar 24 is varied into several positions.

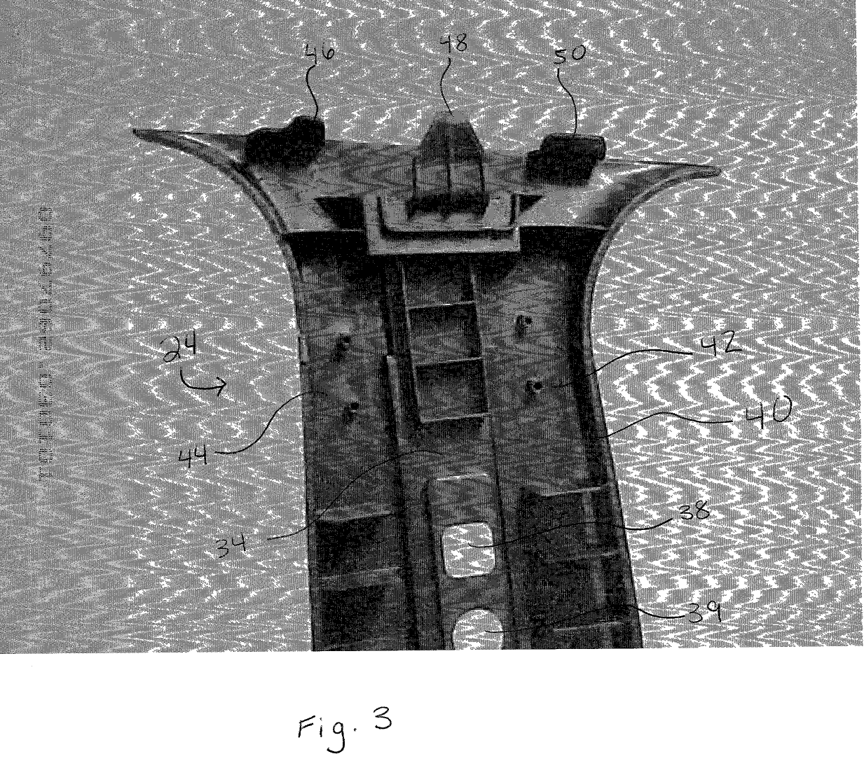

Referring now to FIG. 3, a reverse side view of the B pillar 24 showing an adjacent interior shell portion 40 is shown. As shown, interior shell portion 40 is configured to receive a honeycomb structure or like resilient material as discussed in greater detail hereafter to allow the B pillar to satisfy certain safety requirements such as, for example, head impact requirements. The B pillar 24 has adjacent dual mounting surfaces 42 and 44. Sliding mechanism 34 is disposed between the dual mounting surfaces 42 and 44. The pillar 24 includes fasteners 46, 48, and 50 that are used to securely snap the pillar 24 into flush connection with the van frame body's upright portion (not shown).

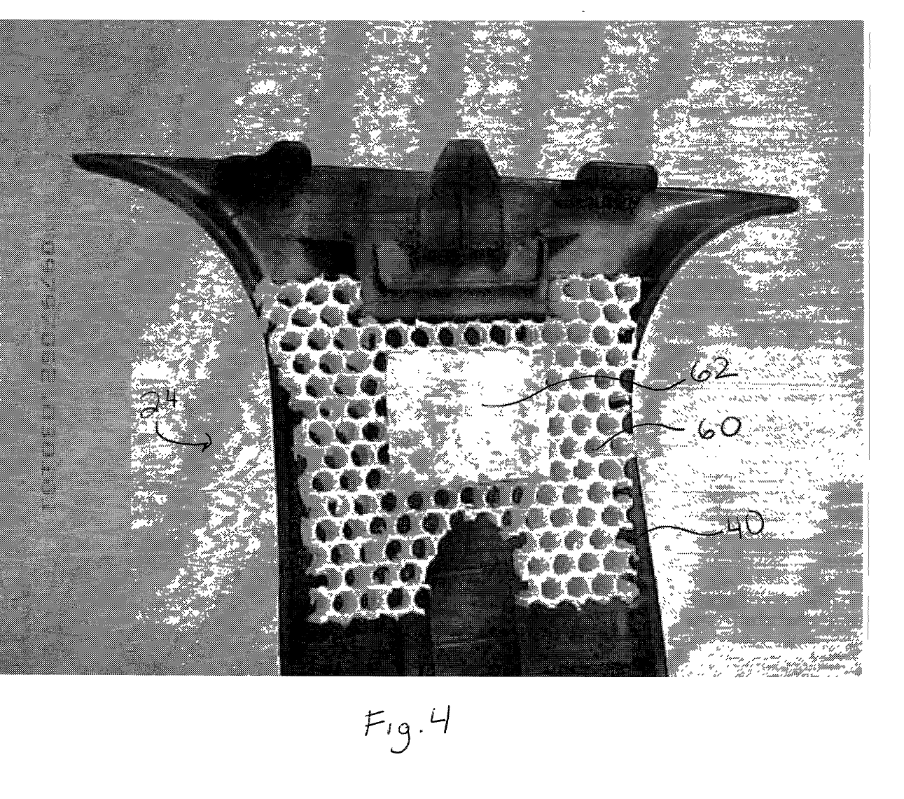

Referring now to FIG. 4, a rear side view of B pillar 24 is shown. Honeycomb structures 60 and 62 are affixed to the adjacent interior shell portion 40 of B pillar 24 after the B pillar 24 is formed. In accordance with this aspect of the invention, a mechanical means such as, for example, a gluing or press-fit technique is used to establish the connection.

In the illustrated embodiment of the invention, honeycomb structures 60 and 62 are glued together to form one unitary structure. However, it should be understood that the honeycomb structures 60 and 62 also can be formed in a one-piece configuration. In the illustrated embodiment of the invention, the honeycomb structure 60 is configured to be mounted on the B pillar 24 and a corresponding section of the automobile frame to allow the B pillar 24 to meet certain safety requirements such as, for example, head impact collision requirements as discussed in greater detail hereafter.

In the illustrated embodiment of the invention, one surface of the honeycomb member 60 is mechanically affixed or glued to the interior mounting face 40 of the B pillar 24. When the B pillar 24 is fastened to the vehicular frame, the exterior surface of honeycomb structures 60 and 62 are placed in contact with the corresponding upright portion of the vehicle. Thus, a unitary connection is established between the upright portion of the vehicle, the honeycomb structures 60 and 62, and the B pillar 24. The honeycomb structures 60 and 62 thereby provide the B pillar with certain physical characteristics so as to satisfy certain safety standards such as, for example, head impact collision standards.

The shape and configuration of the honeycomb structures 60 and 62 are determined in accordance with the shape of the exterior shell portion 40 of the B pillar 24 to which they are affixed. As shown in FIG. 4, the honeycomb structures 60 and 62 are affixed flush upon the inside of the mounting surface and spans the general width of the mounting surface 40.

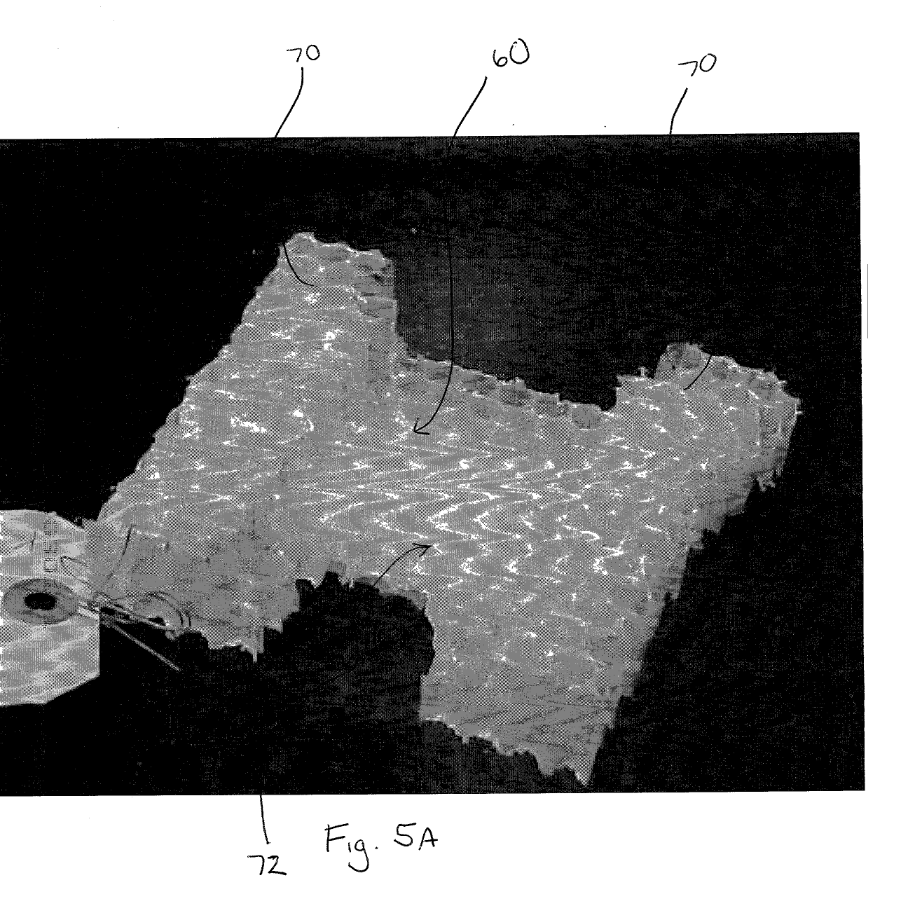

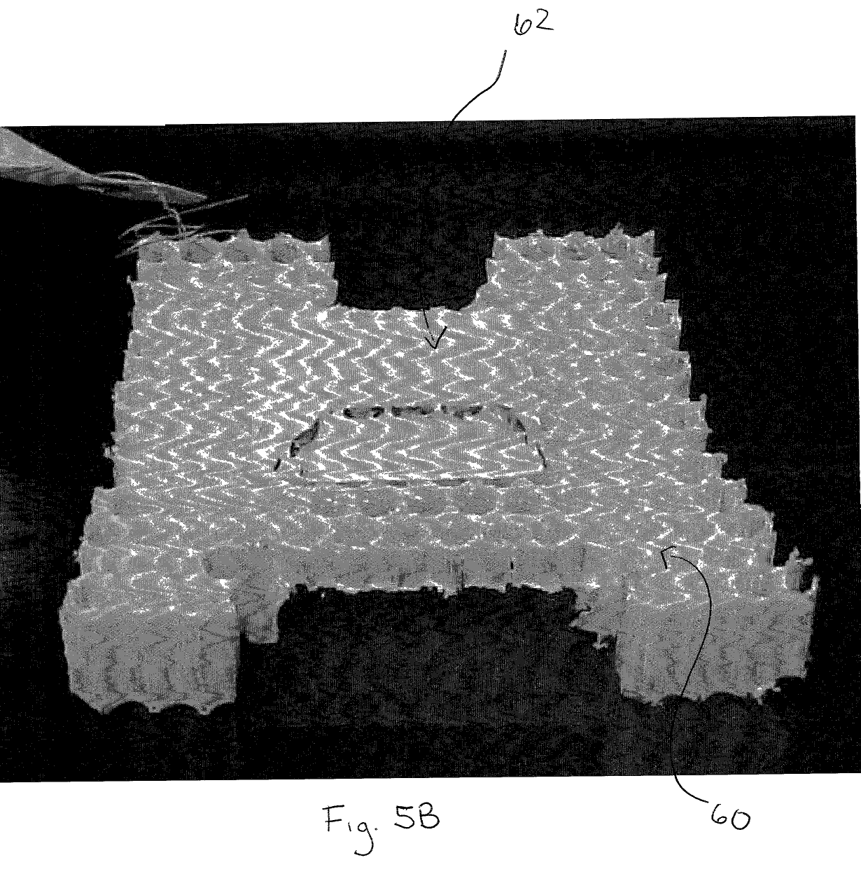

Referring to FIG. 5A, a bottom, perspective view of honeycomb structure 60 is shown. In the illustrated embodiment of the invention, the bottom surface of the honeycomb structure 60 that is affixed to the B-pillar 24 includes a channel 72 that allows the sliding mechanism of the seat belt assembly (not shown) to be moved by the occupant of a vehicle without resistance. Honeycomb structure 60 also includes two mounting portions 70 that are affixed to the mounting surfaces 42 and 44 that are defined on B pillar 24 (FIG. 3). It should be understood that, in accordance with the teachings of the present invention, the shape of bottom surface of honeycomb structure 60 is defined in accordance with the type of automobile interior component that is being used, as well as any other automobile components that are located in close proximity to the honeycomb structure such as air conditioning ducts, electrical conduits, and the like.

Referring to FIG. 5B, a top, perspective view of the honeycomb structures 60 and 62 are shown. In the illustrated embodiment of the present invention, the upper surfaces of honeycomb structures 60 and 62 generally correspond to the portion of the automobile frame to which they are connected so that the surface area of contact therebetween is generally maximized.

Various methods for manufacturing automobile interior parts by insert molding are disclosed, for example, in U.S. Pat. Nos. 6,180,207, 6,132,662 and 6,158,764. In accordance with certain teachings of these patents, a plastic preform part is inserted into a mold cavity of an injection mold. Thereafter, a thermoplastic elastomer or molten resin is injected into the mold cavity of the injection mold to generate a substrate of the preform part. The resulting part is cooled and removed from the mold. The contents of the above-referenced patents are incorporated by reference into this application as if fully set forth herein.

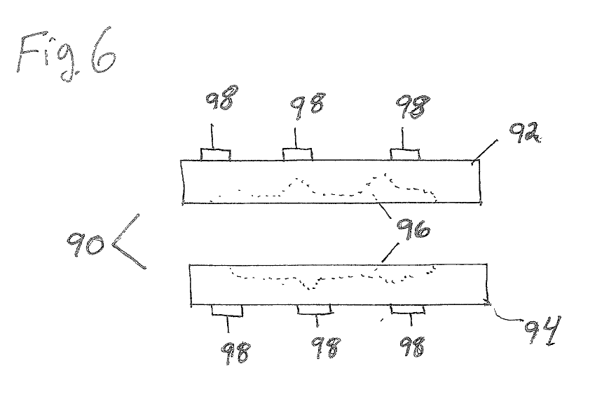

FIG. 6 is a side view of a exemplary mold 90 that is suitable for use in connection with aspects of the present invention disclosed herein. In particular, mold 90 can be utilized to manufacture automobile interior components that satisfy certain safety requirements such as, for example, head impact collision requirements. In accordance with this aspect of the present invention, a honeycomb structure is inserted into the article defining cavity of a mold during the molding process. For example, mold 90 is used to manufacture automobile interior components such as, for example, B pillar 24 that is shown in FIG. 1. Also, for example, the honeycomb structure is formed to have a desired shape as discussed above with reference to FIGS. 1-5B. However, it should be understood that mold 90 can be used to manufacture any type of automobile interior component desired.

In the illustrated embodiment of the invention, mold 90 forms a portion of an insert molding apparatus. In this regard, mold 90 includes first and second mold halves 92 and 94 that are movable with respect to each other between open and closed positions. When the mold 90 is in a closed position, an article defining cavity 96 is defined between the mold halves 92 and 94 as shown in FIG. 6. The shape of the article defining cavity 96 corresponds to the automobile interior component that is to be manufactured. Mold 90 includes a number of heating units 98 that are used to heat the moldable material that is contained in the article defining cavity 96 during portions of the molding process.

In the illustrated embodiment of the invention, an insert molding process is used to form automobile interior components by the following steps. First, a honeycomb structure having a desired shape is provided. In one example, the honeycomb structure can be shaped in accordance with the shape of the honeycomb structures 60 and 62 that are described above with regard to FIGS. 1-5. Second, the honeycomb structure is positioned at a predetermined position on one of the mold halves 92 and 94. This position corresponds to the location on an automobile interior component that is to be manufactured at which a honeycomb structure is to be located. Positioning the honeycomb structure in this manner allows the automobile interior component to satisfy safety standards as discussed above.

Third, a predetermined amount of a thermoplastic resin, elastomer, or like material is injected into the article defining cavity 96. This causes an automobile interior component to be formed around the honeycomb structure. After the insert molding process is completed, the honeycomb structure is integrally bonded to the automobile interior component. The, the automobile interior component/honeycomb structure assembly is removed from the mold 90.

From the foregoing it will be observed that numerous modifications and variations can be effectuated without departing from the true spirit and scope of the novel concepts of the present invention. It is to be understood that no limitation with respect to the specific embodiments illustrated is intended or should be inferred. The disclosure is intended to cover by the appended claims all such modifications as fall within the scope of the claims when the claims are properly interpreted.

1. A method of manufacturing an automobile interior component that satisfies certain impact standards, said method comprising the steps of:
positioning a honeycomb structure at a desired location that is defined on an article defining cavity of an insert molding apparatus, said honeycomb structure having a predetermined, desired shape;
injecting a predetermined quantity of a moldable material into said article defining cavity of said insert molding apparatus;
using said insert molding apparatus to form an automobile interior component so that said honeycomb structure is bonded to said automobile interior component; and
wherein when said automobile interior component is mounted on an automobile frame, said honeycomb structure contacts said frame and an exterior surface of said automobile interior component that defines at least in part an interior surface of a vehicle interior is directly coupled to said automobile interior component, whereby said automobile interior component satisfies certain safety standards.

2. The method of manufacturing an automobile interior component of claim 1, wherein said automobile interior component comprises a pillar.

3. The method of manufacturing an automobile interior component of claim 1, wherein said automobile interior component comprises a console.

4. The method of manufacturing an automobile interior component of claim 1, wherein said automobile interior component comprises a dashboard.

5. The method of manufacturing an automobile interior component of claim 1, wherein said automobile interior component comprises interior side paneling.

6. The method of manufacturing an automobile interior component of claim 1, wherein said automobile interior component comprises a headliner.
